(19) United States
(12) Patent Application Publication
(10) Pub. No.: US 2012/0140635 A1
(43) Pub. Date: Jun. 7, 2012

(54) Data relay device and route selection method

(75) Inventors: Aki Aoki, Chigasaki (JP); Takuya Okamoto, Kawasaki (JP)

(73) Assignee: FUJITSU LIMITED, Kawasaki (JP)

(21) Appl. No.: 12/662,941

(22) Filed: May 12, 2010

Related U.S. Application Data
(63) Continuation of application No. PCT/JP2007/072014, filed on Nov. 13, 2007.

(51) Int. Cl. H04L 12/26

(52) U.S. Cl. 370/238

(57) ABSTRACT

A data relay device stores therein a total of costs between nodes in each of routes and, if a path having a predetermined bandwidth is to be established from a start node that is the device in a network to an end node, refers to the total cost while converging a number of routes required for obtaining the predetermined bandwidth, thereby virtually establishing one path. The data relay device includes a group organizing unit that organizes groups of routes such that a difference between total costs of the respective routes is equal to or less than a predetermined value preset in the data relay device; and a route selecting unit that selects a number of routes corresponding to the bandwidth of the path from an identical group in the groups organized by the group organizing unit in response to a request for establishing a path to the end node.

### CROSS-REFERENCE TO RELATED APPLICATION(S)

This application is a continuation of International Application No. PCT/JP2007/072014, filed on Nov. 13, 2007, the entire contents of which are incorporated herein by reference.

### FIELD

The embodiments discussed herein are directed to a data relay device and a route selection method.

### BACKGROUND

Heretofore, technology relating to data transmission in an Internet Protocol (IP) network has been designed (for example, see Japanese Laid-open Patent Publication No. 09-191322), and a path that allows high-speed data transmission from a predetermined start node to an end node has been available with the advent of Multi-Protocol Label Switching (MPLS).

Furthermore, in recent years, a range in which a path can be available has been expanded to a Synchronous Optical Network/Synchronous Digital Hierarchy (SONET/SDH) network as well as an IP network with the advent of Generalized Multi-Protocol Label Switching (GMPLS) that is generalized MPLS.

Virtual Concatenation (VCAT), which is a technology for controlling the bandwidth of a path available on the SONET/SDH network, has received attention. To explain the reason why VCAT has received attention, the bandwidth of a path available on the SONET/SDH network has been heretofore restricted to quadrupled values, i.e., 150 Mbps, 600 Mbps, 2.4 Gbps, and 10 Gbps. On the other hand, in VCAT, it is possible to specify settings of the bandwidth of a path in a more detailed manner by using any multiple of values, i.e., 50 Mbps, 100 Mbps, 150 Mbps, and 50 Mbps. This is why VCAT has received attention.

Here, a detailed explanation will be given of a method for establishing a path on the SONET/SDH network on the basis of VCAT.

First, a management device issues, to a data relay device that is a start node on the SONET/SDH network, a request for establishing a path having a bandwidth of, for example, 200 Mbps to a predetermined end node in accordance with an operator's instruction.

Upon receiving the above-described request from the management device, the data relay device retrieves a route (in most cases, a route via a different node) for reaching the end node from the device and, as a result, determines a plurality of routes. On the basis of VCAT, the data relay device ensures a bandwidth of 50 Mbps for each of the determined routes and virtually converges a plurality of routes, thereby setting the bandwidth of the path in a more detailed manner. That is, the data relay device needs to select four routes from the determined plurality of routes in response to the request for establishing a path having a bandwidth of 200 Mbps.

The data relay device selects four routes from the determined plurality of routes in accordance with a numeric value called a cost. The cost is a numeric value defined by GMLPS and is determined with respect to a link (an interval between nodes in a network) by using a prescribed calculation method.

The data relay device retrieves routes, calculates the costs of links included in the route, and calculates the total cost, which is the total of the costs, for each route. The data relay device then selects four routes in ascending order with respect to the total cost and converges the four selected routes, thereby establishing a virtual path having a bandwidth of 200 Mbps.

Although data having a bandwidth of up to 200 Mbps is transmitted to the path established as described above, the time from when the data is transmitted from a start node to when the data is received by an end node is different in each of the four converged routes. Therefore, the end node has a function of absorbing the transmission delay difference of data. Furthermore, the differential delay tolerance, which is a numeric value equivalent to a cost defined by GMLPS, is set in the end node, and it is preferable that the difference between the total costs of the routes is equal to or less than the differential delay tolerance.

As described above, the data relay device selects the required number of routes from a plurality of routes; however, a low absolute value of the total cost is a criterion for selection and a low relative value between the total costs is not the criterion.

The difference between the total costs of the routes selected according to such a criterion sometimes can be a large value.

If the difference between the total costs of the routes exceeds the differential delay tolerance set in the end node, a problem occurs in that a differential delay alarm is generated on the SONET/SDH network and signals cannot be restored.

### SUMMARY

According to an aspect of an embodiment of the invention, a data relay device, with respect to a plurality of different routes for reaching a predetermined end node from the device, stores therein a total cost that is a total of costs between nodes in each of the routes and, if a path having a predetermined bandwidth is to be established from a start node that is the device in a network to the end node, refers to the total cost while converging a number of routes required for obtaining the predetermined bandwidth, thereby virtually establishing one path. The data relay device includes a group organizing unit that organizes groups of routes such that a difference between total costs of the respective routes is equal to or less than a predetermined value preset in the data relay device; and a route selecting unit that selects a number of routes corresponding to the bandwidth of the path from an identical group in the groups organized by the group organizing unit in response to a request for establishing a path to the end node.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram that illustrates the configuration of a data relay device according to a first embodiment;

FIG. 2 is a diagram that illustrates a specific example of a network and predetermined routes in the network;

FIG. 3 is a diagram that illustrates an example of information stored in a total-cost storage unit;

FIG. 4 is a diagram that illustrates an example of information stored in an ascending-order total-cost storage unit;

FIG. 5 is a diagram that illustrates an example of information stored in a post-grouping total-cost storage unit;

FIG. 6 is a diagram that illustrates an example of information stored in a route-selection reference-table storage unit;

FIG. 7 is a flowchart that illustrates the procedure performed by a route-selection reference-table creating unit;

FIG. 8 is a block diagram that illustrates the configuration of a data relay device according to a second embodiment;

FIG. 9 is a diagram that illustrates the process performed by a group-retrieval processing unit; and

FIG. 10 is a flowchart that illustrates the procedure performed by a route instructing unit.

### DESCRIPTION OF EMBODIMENTS

Preferred embodiments of the present invention will be explained with reference to accompanying drawings.

### [a] First Embodiment

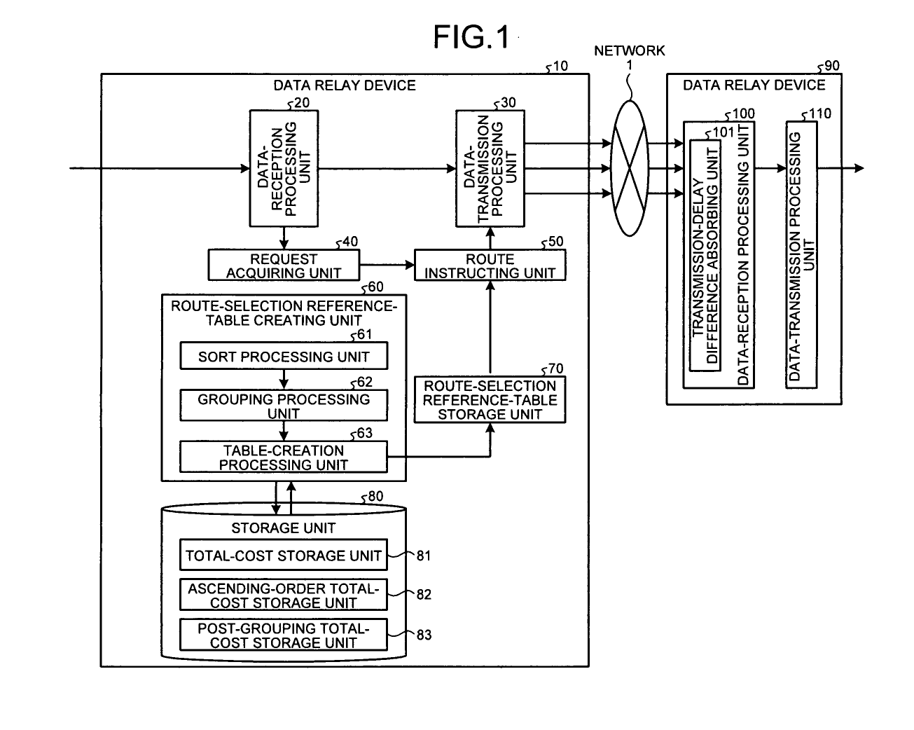

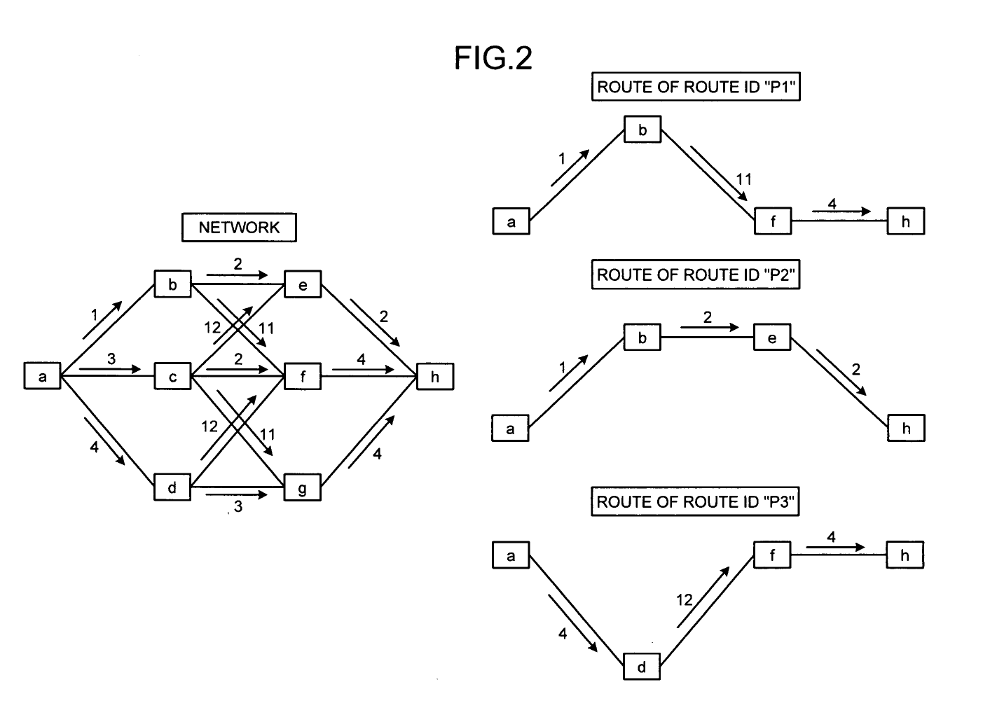

First, an explanation will be given of the brief overview of a data relay device according to the present invention with reference to FIG. 1 and FIG. 2. FIG. 1 is a block diagram that illustrates the configuration of a data relay device according to a first embodiment, and FIG. 2 is a diagram that illustrates a specific example of a network and predetermined routes in the network.

A data relay device 10 itself is one of the nodes in a network 1, thereby constituting the network 1. The data relay device 10 is connected to a data relay device 90, which is also one of the nodes in the network 1, via the network 1 such that they can communicate with each other.

Taking a specific example for explanation, as illustrated in FIG. 2, in the network constituted by eight nodes with the marks “a” to “h” attached thereto, the data relay device 10 and the data relay device 90 are present in the network with a positional relation of the nodes “a” and the node “h”, respectively.

Referring back to FIG. 1, the data relay device 10 stores therein in advance, with respect to a plurality of different routes for reaching the data relay device 90 from the device, a total cost that is the total of costs (the cost will be explained later) between nodes in each of the routes.

Taking a specific example for explanation, as illustrated in FIG. 2, the data relay device 10 as the node “a” assigns a route ID to each route for reaching the data relay device 90 as the node “h” from the device and stores therein the route ID as route information. For example, the data relay device 10 recognizes the route via the node “b” and the node “f” as the route ID “P1”. The data relay device 10 then stores in advance the route ID and the total cost of the route with the route ID assigned thereto in a total-cost storage unit 81, which will be explained later, such that they are linked to each other.

Referring back to FIG. 1, upon establishing a path having a predetermined bandwidth between the device and the data relay device 90 on the basis of VCAT, the data relay device 10 divides data and transmits the divided data via a plurality of different routes for reaching the data relay device 90 from the device.

Taking a specific example for explanation, as illustrated in FIG. 2, upon establishing a path of 150 Mbps between the device and the data relay device 90 as the node “h”, for example, the data relay device 10 as the node “a” divides data by 50 Mbps each and transmits the divided data via three routes, i.e., the route with the route ID “P1” assigned thereto, the route with the route ID “P2” assigned thereto, and the route with the route ID “P3” assigned thereto.

Referring back to FIG. 1, the data relay device 90 receives the data that has been transmitted via the plurality of different routes from the data relay device 10 and absorbs any transmission delay difference that occurs among the routes while multiplexing the divided data. Further, the data relay device 90 sets a differential delay tolerance that is a numeric value equivalent to the above-described cost. If the difference among the total costs of the routes through which the data transmitted from the data relay device 10 has flowed exceeds the differential delay tolerance, the data relay device 90 generates a differential delay alarm in the network 1. In the present embodiment, an explanation is given on the assumption that the data relay device 10 stores therein in advance the differential delay tolerance. The above is the brief overview of the data relay device.

Next, an explanation will be given of the configuration of the data relay device with reference to FIG. 1. As illustrated in the same figure, the data relay device 10 includes a data-reception processing unit 20, a data-transmission processing unit 30, a request acquiring unit 40, a route instructing unit 50, a route-selection reference-table creating unit 60, a route-selection reference-table storage unit 70, and a storage unit 80.

The data-reception processing unit 20 receives data transmitted to the data relay device 10 and processes it. Specifically, upon receiving data to be transmitted through a path established between the data relay device 10 and the data relay device 90, the data-reception processing unit 20 outputs the data to the data-transmission processing unit 30 that is explained later. Upon receiving a request relating to establishment of a path, which is transmitted from a management device that manages the network 1, the data-reception processing unit 20 outputs the request to the request acquiring unit 40 that is explained later.

The data-transmission processing unit 30 transmits data to the data relay device 90 on the basis of VCAT. Specifically, upon receiving, from the data-reception processing unit 20, data to be transmitted to the data relay device 90 via a path, the data-transmission processing unit 30 divides the received data and transmits the divided data via the routes currently instructed by the route instructing unit 50 that is explained later.

An explanation is given above of the data-reception processing unit 20 and the data-transmission processing unit 30 that perform the processing operation described in the brief overview of the data relay device 10.

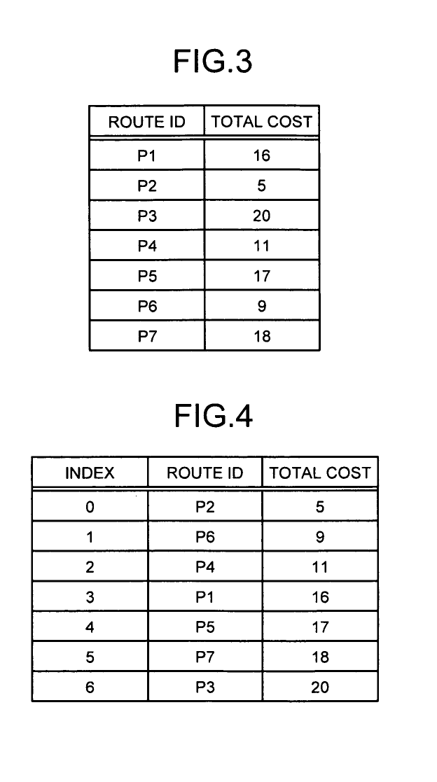

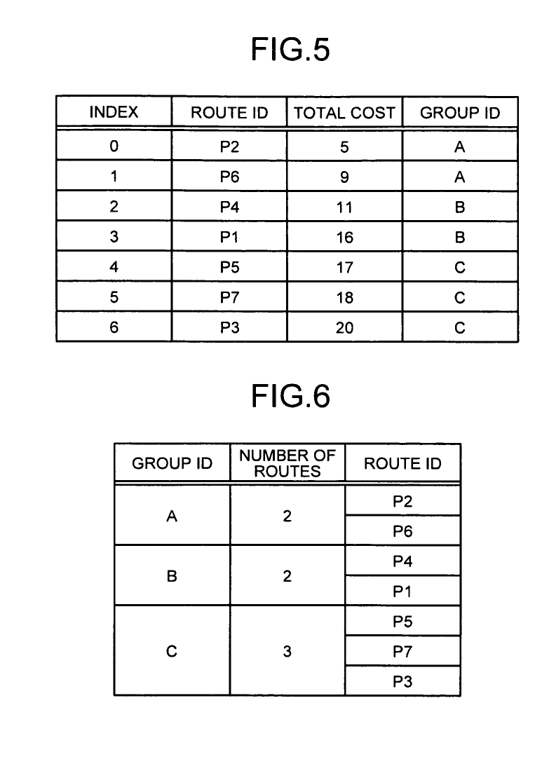

An explanation will be given below of the components of the data relay device 10 particularly associated with the present invention with reference to FIG. 2 to FIG. 6. FIG. 3 is a diagram that illustrates an example of information stored in the total-cost storage unit, FIG. 4 is a diagram that illustrates an example of information stored in an ascending-order total-cost storage unit, FIG. 5 is a diagram that illustrates an example of information stored in a post-grouping total-cost storage unit, and FIG. 6 is a diagram that illustrates an example of information stored in the route-selection reference-table storage unit.

The storage unit 80 stores therein data, or the like, to be used for various processes by the route-selection reference-table creating unit 60 and, as the units particularly closely associated with the present invention, includes the total-cost storage unit 81, an ascending-order total-cost storage unit 82, and a post-grouping total-cost storage unit 83.

With respect to a plurality of different routes for reaching the data relay device 90 from the data relay device 10, the total-cost storage unit 81 stores therein the total cost that is the total of costs with respect to links included in each of the routes.

The cost is a numeric value defined by GMLPS and is determined for a link (an interval between nodes in the network) by using a predetermined calculation method. For example, in the network illustrated in FIG. 2, the cost “1” is determined for the interval between the node “a” and the node “b”. Furthermore, in the route with the route ID “P1”, the cost “1” is determined for the interval between the node “a” and the node “b”, the cost “11” for the interval between the node “b” and the node “f”, and the cost “4” for the interval between the node “f” and the node “h” so that the total cost is “16” that is the total of “1”, “11”, and “4”. In the routes with the route ID “P2” and the route ID “P3”, the total costs are “5” and “20”, respectively. When the data relay device 10 is connected to the network 1, the data relay device 10 collects information relating to the connection among all nodes in the network 1 and calculates the costs. With respect to a plurality of different routes for reaching the data relay device 90 from the device, the data relay device 10 then calculates the total of costs of links included in each of the routes and stores it for each route in the total-cost storage unit 81.

As a result, specifically, as illustrated in FIG. 3, the total-cost storage unit 81 stores therein the route ID and the total cost such that they are linked to each other. For example, as illustrated in FIG. 3, the total-cost storage unit 81 stores therein the route ID “P1” and the total cost “16” such that they are linked to each other.

The ascending-order total-cost storage unit 82 stores therein a result obtained by sorting the data stored in the total-cost storage unit 81 in ascending order with regard to the total cost. Specifically, as illustrated in FIG. 4, the ascending-order total-cost storage unit 82 further stores therein an index, which is a sequential number beginning from “0” and used for information processing by a grouping processing unit 62, explained later, with respect to the correspondence relation between the route ID and the total cost such that they are linked to one another. For example, as illustrated in FIG. 4, the ascending-order total-cost storage unit 82 stores therein the index “0”, the route ID “P2”, and the total cost “5” such that they are linked to one another.

The post-grouping total-cost storage unit 83 stores therein a result obtained by grouping the data stored in the ascending-order total-cost storage unit 82. Specifically, as illustrated in FIG. 5, the post-grouping total-cost storage unit 83 further stores therein a group ID, by which the group to which the route with the route ID assigned thereto belongs can be uniquely identified, with respect to the correspondence relation among the index, the route ID, and the total cost such that they are linked to one another. For example, as illustrated in FIG. 5, the post-grouping total-cost storage unit 83 stores therein the index “0”, the route ID “P2”, the total cost “5”, and the group ID “A” such that they are linked to one another.

The route-selection reference-table storage unit 70 stores therein a group organized by the route-selection reference-table creating unit 60 explained later and the number of routes included in the group such that they are linked to each other.

Specifically, as illustrated in FIG. 6, the route-selection reference-table storage unit 70 stores therein a group ID, the number of routes that is the number of routes included in the group identified by the group ID, and the route IDs assigned to the routes included in the group such that they are linked to one another. For example, as illustrated in FIG. 6, the route-selection reference-table storage unit 70 stores therein the route ID “P2” and the route ID “P6” with respect to the correspondence relation between the group ID “A” and the number of routes “2” such that they are linked to one another.

The route-selection reference-table creating unit 60 is a processing unit that creates a route-selection reference table to be stored in the route-selection reference-table storage unit 70 and, specifically, is constituted by a sort processing unit 61, a grouping processing unit 62, and a table-creation processing unit 63.

The sort processing unit 61 sorts the correspondence relation between the route ID and the total cost in accordance with the size of the total cost. Specifically, the sort processing unit 61 reads the correspondence relation stored in the total-cost storage unit 81 and sorts the read correspondence relation in accordance with the size of the total cost. The sort processing unit 61 then assigns an index, which is a sequential number beginning from “0”, to the sorted correspondence relation and stores it in the ascending-order total-cost storage unit 82.

The grouping processing unit 62 organizes groups of routes such that the difference among the total costs of the respective routes is equal to or less than a predetermined value that is preset in the data relay device 10. The time when the group is organized is a predetermined time before a request for establishing a path to the data relay device 90 is issued to the data relay device 10. Specifically, the grouping processing unit 62 processes the information stored in the ascending-order total-cost storage unit 82 and stores the processing result in the post-grouping total-cost storage unit 83. The details of the processing performed by the grouping processing unit 62 will be explained later with reference to a flowchart.

The table-creation processing unit 63 creates a table in which a group organized by the grouping processing unit 62 and the number of routes included in the group are linked to each other. Specifically, the table-creation processing unit 63 calculates, for each group ID, the number of correspondence relations that include the same group ID in accordance with the table stored in the post-grouping total-cost storage unit 83. The table-creation processing unit 63 then determines the value calculated with respect to the group ID as the number of routes, creates a table in which the group ID, the number of routes, and the route ID of the routes included in the group identified by the group ID are linked to one another, and stores it in the route-selection reference-table storage unit 70.

The request acquiring unit 40 calculates the number of routes from the request for establishing a path. Specifically, when the data-reception processing unit 20 receives a request relating to establishment of a path, which is transmitted from the management device, the request acquiring unit 40 acquires bandwidth information contained in the request, calculates the required number of routes from the bandwidth information, and outputs it to the route instructing unit 50. For example, the request acquiring unit 40 calculates the number of routes “3” from the request for establishing a path of 150 Mbps. Although the information contained in the request includes identification information on a node that is the end point of a path, or the like, as well as the bandwidth information, the end point of the path is limited to only the data relay device 90 and an explanation for information other than the bandwidth information is omitted in the present embodiment.

In response to the request for establishing a path to the data relay device 90, the route instructing unit 50 selects the number of routes corresponding to the bandwidth of the path from the identical group in the groups organized by the route-selection reference-table creating unit 60. Specifically, upon receiving the number of routes output from the request acquiring unit 40, the route instructing unit 50 selects the correspondence relation that includes the number of routes equal to or more than the received number of routes in accordance with the table stored in the route-selection reference-table storage unit 70. The route instructing unit 50 then reads the route IDs from the selected correspondence relation and instructs the data-transmission processing unit 30 to divide data and transmit the divided data via the routes indicated by the route IDs.

Subsequently, an explanation will be given of the configuration of the data relay device 90 with reference to FIG. 1. As illustrated in the same figure, the data relay device 90 includes, as the units particularly closely associated with the present invention, a data-reception processing unit 100 and a data-transmission processing unit 110.

Upon receiving the data that has been transmitted from the data relay device 10 via a plurality of different routes, the data-reception processing unit 100 multiplexes the divided data while a transmission-delay difference absorbing unit 101 absorbs the transmission delay difference that has occurred among the routes. The data-reception processing unit 100 then outputs the multiplexed data to the data-transmission processing unit 110.

Upon receiving the multiplexed data from the data-reception processing unit 100, the data-transmission processing unit 110 further transmits the data to a predetermined relay point.

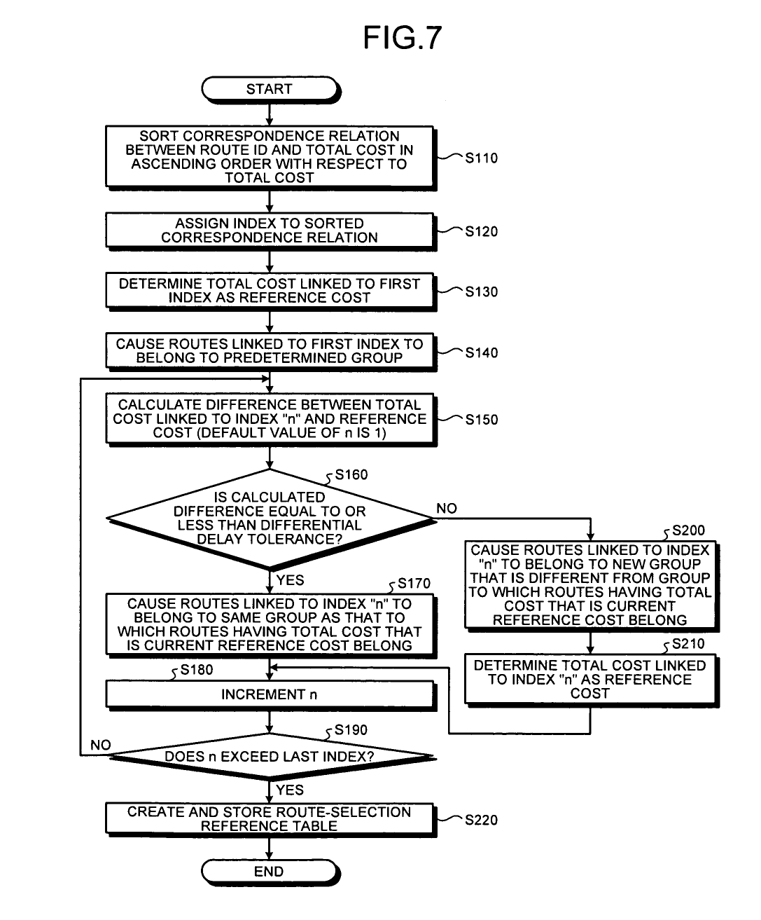

Next, an explanation will be given of the processing operation of the route-selection reference-table creating unit 60 in the data relay device 10 with reference to the flowchart of FIG. 7. The procedure illustrated in the same figure is a process performed at a predetermined time (for example, when the data relay device 10 is connected to the network 1) before a request for establishing a path to the data relay device 90 is issued to the data relay device 10.

As illustrated in the same figure, in the route-selection reference-table creating unit 60, the sort processing unit 61 sorts the correspondence relation between the route ID and the total cost in ascending order with respect to the total cost (Step S110). The sort processing unit 61 then assigns an index, which is a sequential number beginning from “0”, to the sorted correspondence relation (Step S120) and stores it in the ascending-order total-cost storage unit 82.

The grouping processing unit 62 determines the total cost linked to the first index as a reference cost (Step S130), causes the routes indicated by the route ID with the first index assigned thereto to belong to a predetermined group (Step S140), and links the group ID for identifying the group to the route ID.

The grouping processing unit 62 then calculates the difference between the total cost linked to the index “n (the default value of n is 1)” and the reference cost (Step S150).

The grouping processing unit 62 then determines whether the calculated difference is equal to or less than the differential delay tolerance of the data relay device 90 (Step S160). The data relay device 10 stores therein the differential delay tolerance of the data relay device 90 at a predetermined time.

If the calculated difference is equal to or less than the differential delay tolerance of the data relay device 90 as a result of determination (Yes at Step S160), the grouping processing unit 62 causes the routes identified by the route ID linked to the index “n” to belong to the same group as that to which the routes identified by the route ID linked to the total cost that is the current reference cost belong (Step S170).

Conversely, if it exceeds the above-described differential delay tolerance as a result of determination (No at Step S160), the grouping processing unit 62 causes the routes identified by the route ID linked to the index “n” to belong to a new group that is different from the group to which the routes identified by the route ID linked to the total cost that is the current reference cost belong (Step S200) and determines the total cost linked to the index “n” as a reference cost (Step S210).

After causing the routes identified by the route ID linked to the index “n” to belong to the same group as that to which the routes identified by the route ID linked to the total cost that is the current reference cost belong or after determining the total cost linked to the index “n” as the reference cost (Step S170 or Step S210), the grouping processing unit 62 increments n (Step S180). The grouping processing unit 62 then determines whether n exceeds the last index (Step S190) and, if it does not exceed the last index (No at Step S190), the process from Step S150 to Step S210 is repeated until n exceeds the last index. The process is repeated by the grouping processing unit 62 until n exceeds the last index, and then the correspondence relations illustrated in FIG. 5 are stored in the post-grouping total-cost storage unit 83.

If n exceeds the last index (Yes at Step S190), the table-creation processing unit 63 creates the route-selection reference table in accordance with the correspondence relations stored in the post-grouping total-cost storage unit 83, stores it in the route-selection reference-table storage unit 70 (Step S220), and then terminates the process.

The grouping performed as a result of the above-described process is an example of grouping with respect to a plurality of different routes, but the present invention is not limited to this. Although the group ID is linked to the route ID without overlapping in FIG. 5, for example, the group ID “A” and the group ID “B” may be linked to the route ID “P6” as long as the condition is satisfied such that the difference among the total costs of the respective routes is equal to or less than a predetermined value.

### Advantage of the First Embodiment

As described above, according to the first embodiment, groups of routes are organized such that the difference between the total costs of the respective routes is equal to or less than a predetermined value preset in the data relay device 10. In response to a request for establishing a path to the end node, the number of routes corresponding to the bandwidth of the path is selected from an identical group in the organized groups. Thus, a predetermined value is set as the differential delay tolerance of the data relay device 90 so that the occurrence of a differential delay alarm can be prevented.

Moreover, according to the first embodiment, groups are organized at a predetermined time before a request for establishing a path to the end node is issued, and the organized group and the number of routes included in the group are stored such that they are linked to each other. Then, in response to the request for establishing a path to the end node, routes are selected from a group that includes routes equal to or more than the number of routes necessary for the bandwidth of the path by referring to the correspondence relations. Thus, it is possible to shorten the time it takes to select routes from the time the request is received compared to a method for selecting routes by organizing groups each time a request for establishing a path is received.

### [b] Second Embodiment

According to a second embodiment, groups are organized each time a request is received, and routes are selected in accordance with the organized group. This is to make a flexible combination of routes without fixing a group to which the routes belong and to flexibly respond to the variation of cost.

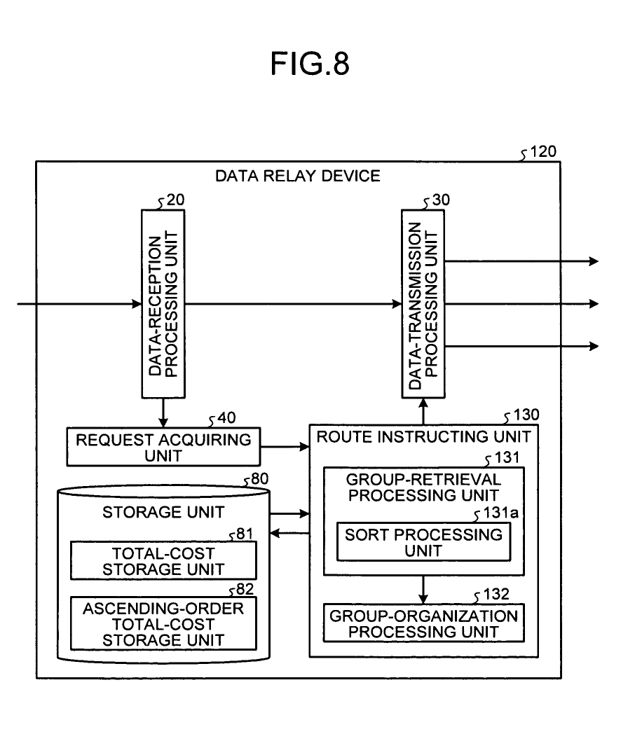

An explanation will be given of the configuration of a data relay device 120 according to the second embodiment with reference to FIG. 8. FIG. 8 is a block diagram that illustrates the configuration of the data relay device according to the second embodiment. As illustrated in the same figure, in the same manner as the first embodiment, the data relay device 120 includes the data-reception processing unit 20, the data-transmission processing unit 30, the request acquiring unit 40, and the storage unit 80, and the storage unit 80 includes the total-cost storage unit 81 and the ascending-order total-cost storage unit 82. The data relay device 120 further includes a route instructing unit 130 that is different from the first embodiment. Explanations are omitted for the units that perform the same processing operation and the units that have the same function as in the first embodiment, and an explanation will be given below of only the route instructing unit 130.

The route instructing unit 130 includes a group-retrieval processing unit 131 and a group-organization processing unit 132 and, in response to a request for establishing a path to the data relay device 90, selects the number of routes corresponding to the bandwidth of the path from an identical group in the groups organized by the group-organization processing unit 132. Specifically, upon receiving the number of routes output from the request acquiring unit 40, the route instructing unit 130 performs a process by using each processing unit included therein and selects routes in the group organized by the group-organization processing unit 132. The route instructing unit 130 then instructs the data-transmission processing unit 30 to divide data and transmits the divided data via the selected routes.

The group-retrieval processing unit 131 sorts all available routes in ascending order with respect to the total cost and retrieves, starting with the smallest value of the total cost in a group ID table, a route group having the group ID number of routes successive in the sorted table for which the difference between the largest cost and the smallest cost included in the route group is equal to or less than a predetermined value.

Specifically, the group-retrieval processing unit 131 includes therein a sort processing unit 131a, and the sort processing unit 131a sorts the correspondence relations stored in the total-cost storage unit 81 in accordance with the size of the total cost. Then, indexes that are sequential numbers beginning from “0” are assigned to the sorted correspondence relations and stored in the ascending-order total-cost storage unit 82.

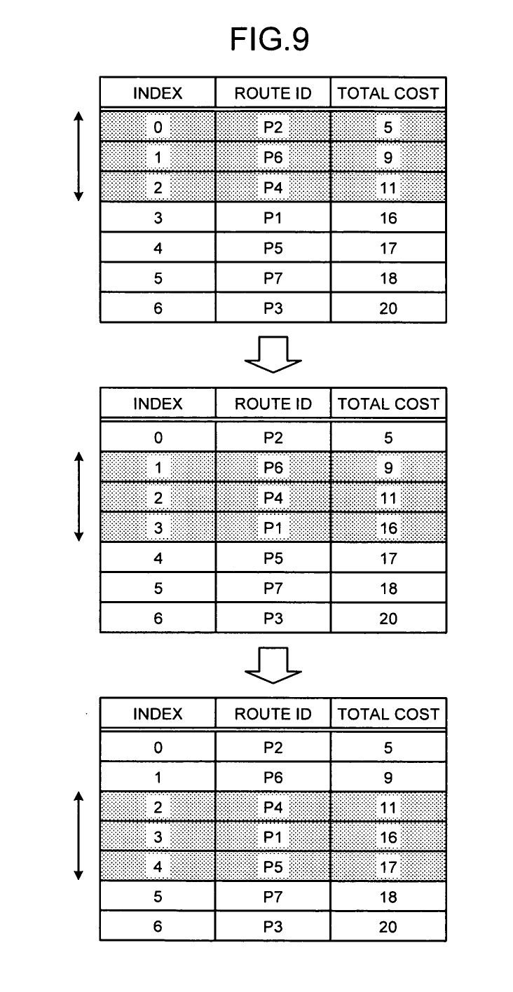

By taking as an example a case where the number of routes received from the request acquiring unit 40 is 3, an explanation will be given below of the process performed by the group-retrieval processing unit 131 after sorting with reference to FIG. 9. As illustrated in the upper section of FIG. 9, the group-retrieval processing unit 131 first selects the total costs corresponding to the indexes “0” to “2”.

The group-retrieval processing unit 131 then calculates the difference “6” between the smallest total cost “5” and the largest total cost “11” in the selected total costs.

If the calculated difference “6” is equal to or less than the differential delay tolerance of the data relay device 90, the group-retrieval processing unit 131 outputs the route IDs that correspond to the selected total costs to the group-organization processing unit 132 explained later. On the other hand, if it exceeds the differential delay tolerance, the group-retrieval processing unit 131 shifts the selection range and selects the total costs corresponding to the indexes “1” to “3”, as illustrated in the middle section of FIG. 9.

The group-retrieval processing unit 131 then calculates the difference “7” between the smallest total cost “9” and the largest total cost “16” in the selected total costs in the same manner.

As described above, the group-retrieval processing unit 131 retrieves the total costs for which the difference between the smallest total cost and the largest total cost is equal to or less than the differential delay tolerance.

During selection of total costs, the total cost of a route that has been already used for establishing a path is exempt from the selection. For example, although the total costs corresponding to the indexes “0” to “2” are selected in the upper section of FIG. 9, if the routes that have the total costs corresponding to the index “1” and the index “2” have been already used for establishing a path, the group-retrieval processing unit 131 selects the total costs corresponding to the index “0”, the index “3”, and the index “4”.

Moreover, the selection range may be shifted so that a predetermined total cost becomes a candidate. For example, the total cost “16” corresponding to the route ID “P1” is determined as a candidate, and first, the total costs with the indexes “1” to “3” assigned thereto are selected. Then, the selection range is shifted in the same manner so that the total costs with the indexes “3” to “5” assigned thereto are finally selected. The total costs that satisfy a condition may be retrieved in the manner described above.

If the total costs that satisfy a condition are obtained as a result of retrieval, the group-retrieval processing unit 131 outputs the route IDs, which are linked to the total costs, to the group-organization processing unit 132.

The group-organization processing unit 132 organizes, as a group, a route group obtained as a result of retrieval performed by the group-retrieval processing unit 131. Specifically, upon receiving the route IDs from the group-retrieval processing unit 131, the group-organization processing unit 132 organizes the routes indicated by the received route IDs as a group.

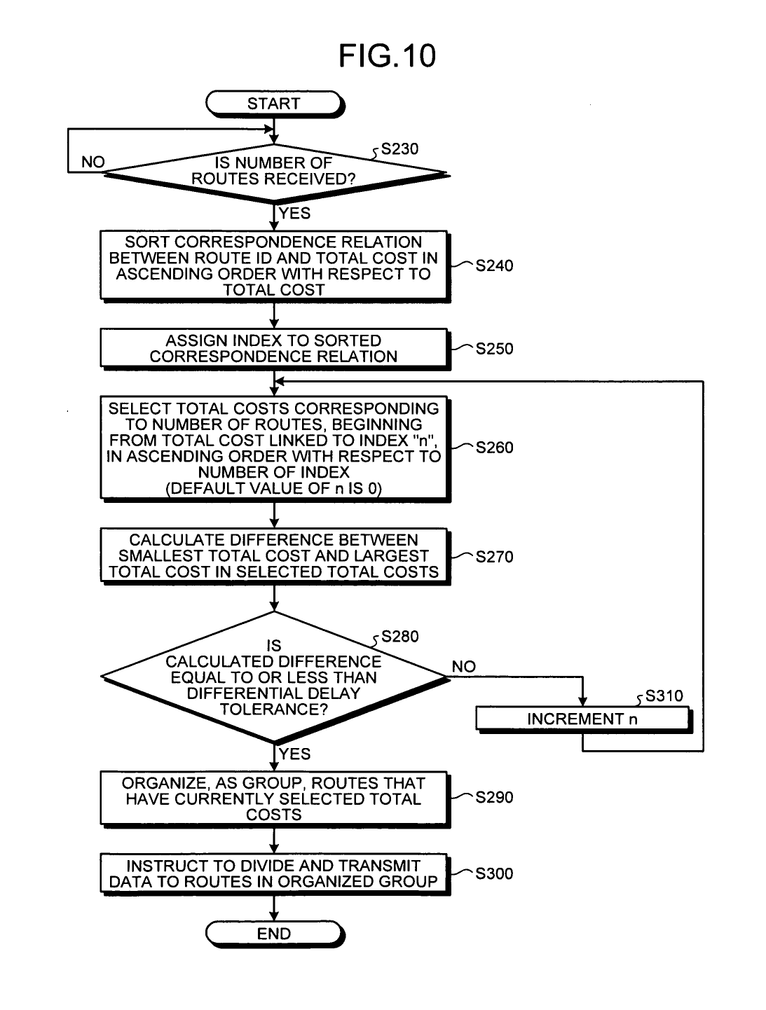

Next, an explanation will be given of the processing operation of the route instructing unit 130 in the data relay device 120 with reference to the flowchart of FIG. 10. The procedure illustrated in the same figure is a process repeatedly performed each time a request for establishing a path to the data relay device 90 is issued to the data relay device 120.

As illustrated in the same figure, when the route instructing unit 130 receives the number of routes from the request acquiring unit 40 (Yes at Step S230), the sort processing unit 131a sorts the correspondence relations between the route IDs and the total costs in ascending order with respect to the total cost (Step S240). The route instructing unit 130 then causes the sort processing unit 131a to assign the indexes, which are sequential numbers beginning from “0”, to the sorted correspondence relations (Step S250) and store them in the ascending-order total-cost storage unit 82.

The route instructing unit 130 then causes the group-retrieval processing unit 131 to select the total costs corresponding to the number of routes, beginning from the total cost linked to the index “n (the default value is 0)”, in ascending order with respect to the number of the index (Step S260).

The route instructing unit 130 then causes the group-retrieval processing unit 131 to calculate the difference between the smallest total cost and the largest total cost in the selected total costs (Step S270).

The route instructing unit 130 then causes the group-retrieval processing unit 131 to determine whether the calculated difference is equal to or less than the differential delay tolerance (Step S280) and, if it exceeds the differential delay tolerance (No at Step S280), n is incremented (Step S310) and then the process returns to Step S260 so that the same process is continuously performed.

Conversely, if it is equal to or less than the differential delay tolerance (Yes at Step S280), the route instructing unit 130 causes the group-organization processing unit 132 to organize, as a group, the routes that have the total costs currently selected by the group-retrieval processing unit 131 (Step S290). The route instructing unit 130 then instructs the data-transmission processing unit 30 to divide data and transmits the divided data via the routes in the organized group (Step S300), and the process is terminated.

### Advantage of the Second Embodiment

As described above, according to the second embodiment, when a request for establishing a path having a predetermined bandwidth to the data relay device 90 is received, the number of routes necessary for obtaining the bandwidth of the path is calculated. Then, all available routes are sorted in ascending order with respect to the total cost, and a route group having the number of routes successive in the sorted table, for which the difference between the largest cost and the smallest cost included in the route group is equal to or less than a predetermined value, is retrieved starting with the smallest value of the total cost in the table. Then, the route group obtained as a result of retrieval is organized as a group. Thus, compared to a method for organizing a group in advance before receiving a request for establishing a path, it is possible to make a flexible combination of routes without fixing a group to which routes belong and to flexibly respond to the variation of cost.

Although an explanation is given above of the preferred embodiments of the data relay devices according to the present invention, each component of the illustrated devices is based on a functional concept and does not necessarily need to be physically configured as illustrated. That is, specific forms of disintegration and integration of each of the devices are not limited to the illustrated ones, and it is possible that all or some of the devices are configured to be functionally or physically disintegrated or integrated in any unit depending on various loads or usage, for example, the sort processing unit 61 and the grouping processing unit 62 can be integrated. All or any part of each processing function performed by each of the devices can be implemented by a CPU and a program analyzed and executed by the CPU or implemented as wired logic hardware.

According to an embodiment of the present invention, groups of routes are organized such that the difference between the total costs of the respective routes is equal to or less than a predetermined value, and the number of routes corresponding to the bandwidth of the path are selected from an identical group in response to a request for establishing a path to an end node so that, if the predetermined value is set as a differential delay tolerance of the end node, the occurrence of a differential delay alarm can be prevented.

Furthermore, according to an embodiment of the present invention, groups are organized at a predetermined time before a request for establishing a path to the end node is issued, and the organized group and the number of routes included in the group are stored such that they are linked to each other. Then, in response to the request for establishing a path to the end node, routes are selected from a group that includes routes equal to or more than the number of routes necessary for the bandwidth of the path by referring to the correspondence relations. Thus, it is possible to shorten the time it takes to select routes from the time the request is received compared to a method for selecting routes by organizing groups each time a request for establishing a path is received.

Moreover, according to an embodiment of the present invention, when a request for establishing a path having a predetermined bandwidth is received, the number of routes necessary for obtaining the bandwidth of the path is calculated. Then, all available routes are sorted in ascending order with respect to the total cost, and a route group having the number of routes successive in the sorted table, for which the difference between the largest cost and the smallest cost included in the route group is equal to or less than a predetermined value, is retrieved starting with the smallest value of the total cost in the table. Then, the route group obtained as a result of retrieval is organized as a group. Thus, compared to a method for organizing a group in advance before receiving a request for establishing a path, it is possible to make a flexible combination of routes without fixing a group to which routes belong and to flexibly respond to the variation of cost.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data relay device that, with respect to a plurality of different routes for reaching a predetermined end node from the device, stores therein a total cost that is a total of costs between nodes in each of the routes and, if a path having a predetermined bandwidth is to be established from a start node that is the device in a network to the end node, refers to the total cost while converging a number of routes required for obtaining the predetermined bandwidth, thereby virtually establishing one path, the data relay device comprising:
a group organizing unit that organizes groups of routes such that a difference between total costs of the respective routes is equal to or less than a predetermined value preset in the data relay device; and
a route selecting unit that selects a number of routes corresponding to the bandwidth of the path from an identical group in the groups organized by the group organizing unit in response to a request for establishing a path to the end node.

2. The data relay device according to claim 1, wherein
the group organizing unit organizes a group at a predetermined time before a request for establishing a path to the end node is issued to the data relay device,
the data relay device further comprising a within-group route-number storage unit that stores therein the group organized by the group organizing unit and a number of routes included in the group such that the group and the number of routes are linked to each other, and
the route selecting unit selects, in response to a request for establishing a path to the end node, routes from a group that includes routes equal to or more than a number of routes necessary for the bandwidth of the path by referring to the within-group route-number storage unit.

3. The data relay device according to claim 1, further comprising:
a route-number calculating unit that, when a request for establishing a path having a predetermined bandwidth to the end node is received, calculates a number of routes necessary for obtaining the bandwidth of the path; and
a route-group retrieving unit that sorts all available routes in ascending order with respect to a total cost and retrieves a route group having the number of routes successive in a sorted table for which a difference between a largest cost and a smallest cost included in the route group is equal to or less than a predetermined value, starting with a smallest value of the total cost in the table, wherein
the group organizing unit organizes, as a group, the route group obtained as a result of retrieval performed by the route-group retrieving unit.

4. A route selection method performed by, with respect to a plurality of different routes for reaching an end node from a start node in a network, referring to a total cost that is a total of costs between nodes in each of the routes while selecting a number of routes required for establishing a path having a predetermined bandwidth, and converging the selected routes so as to virtually establish one path, the route selection method comprising:
organizing groups of routes such that a difference between total costs of the respective routes is equal to or less than a predetermined value; and
selecting a number of routes corresponding to the bandwidth of the path from an identical group in the groups organized at the organizing in response to a request for establishing a path to the end node.
